(19) United States
(12) Patent Application Publication
(10) Pub. No.: US 2006/0215829 A1
(43) Pub. Date: Sep. 28, 2006

(54) Method and system for selectable call termination attempt notification and blocking

(76) Inventor: Paul M. Schwartz, West Bloomfield, MI (US)

Correspondence Address: Schwartz Law Group, PLLC, 6230 Orchard Lake Road, Suite 270, West Bloomfield, MI, 48322, US

(21) Appl. No.: 11/088,051

(22) Filed: Mar. 23, 2005

(51) Int. Cl. H04M 3/42

(52) U.S. Cl. 379/207.02

(57) ABSTRACT

A call notification method and system permits (1) a calling party to select one of a plurality of audible and/or visual call alerts to be provided with a call to a called party on a call termination attempt by the calling party to the called party; (2) a called party to select one of a plurality of audible and/or visual calling alerts to be provided to a calling party on a call termination attempt by the calling party to the called party; and (3) the respective parties to block undesired call alerts and calling alerts, respectively.

### TECHNICAL FIELD

This invention relates generally to telephones and telephone systems and more particularly to a customized call termination attempt notification and blocking system.

### BACKGROUND ART

A typical telephone call (whether implemented on a wireless network or a wireline network) is initiated by a calling party dialing a telephone number or “Directory Number” (DN) of a called party. While few telephone handsets use rotary dials today, the term “dialing” is understood in the art to refer to the process of sending digits to a corresponding switch which are associated with a specific called party. In the wireless world, the receiving switch is generally a Mobile Telephone Switching Center (MTSC). Similarly, in the wireline world, the receiving switch is generally the calling party's local or “serving” central office switch (COS). In either case, the sent digits comprise a telephone number of the called party. In the United States, these digits conform to the North American Numbering Plan (NANP) format of a ten digit number that consists of a 3-digit NPA code (Area Code), 3-digit NXX code (Exchange), and a 4-digit code (Line).

Upon receipt of the sent digits, the central office in conjunction with the telephone network correlates the digits to the called party and attempts to terminate (i.e. connect) the call. If the calling party line is available, a connection is attempted and both the calling party and the called party are notified of the pending status. The former is typically notified by a “ringback”. As those skilled in the art will recognize, a “ringback” is generally an audio tone or series of audio tones (also called “call termination tones”) that a calling party receives after dialing a number (sending digits) but before a connection with the called party is completed so as to alert the calling party that a call termination attempt is being made. This signal is generated by the telephone system (or the calling party Customer Premises Equipment (CPE) device such as a handset or other communication device) rather than the called party and indicates that the called party is receiving a call notification signal. The called party is similarly notified of the call termination attempt by a “ringtone”. Like a ringback, a ringtone is typically an audio tone or series of audio tones that a called party receives after the calling party dials the called party's telephone number but before a connection is made. The ringtone functions to notify that called party that a call termination attempt is in progress. Unlike ringbacks, however, ringtones are typically generated by a calling party's CPE device.

In wireless telephone systems and advanced wireline telephone systems such as, for example, Advanced Intelligent Networks (AIN) and the like, ringtones comprise computer programs which function to tell a corresponding processing unit what the CPE device should do when the CPE receives a call termination attempt. For example, in the case of a ringtone-capable mobile telephone, a range of audible notes may already be stored in a memory chip or collection of memory chips of the handset. The ringtone program provides instructions to a microprocessor which of these notes to play, in which order and at what speed so as to alert the called party of an incoming call. By adjusting the above variables, ringtone programs function to play an infinite number of ringtones.

Presently, call termination tones (“ringbacks”) may be selected or customized by calling parties. Likewise, ringtones may be selected or customized by called parties. Polyphonic capable mobile telephones, for example, permit phones to play more than one note at a time allowing for tunes which are believed to be richer and more harmonized. Many of these phones also permit called parties to select and record songs and voice messages to be played as ringtones. Still further, different ringtones may be assigned by called parties to different incoming numbers as a means to notify the called party of the identity of the calling party. See, for example, U.S. Patent Application Publication 20040120494 to Jiang, published Jun. 24, 2004; U.S. Patent Application Publication 20040081305 to Gonzales, published Apr. 29, 2004; U.S. Patent Application Publication 20040109558 to Koch, published Jun. 10, 2004; U.S. Pat. No. 6,519,326 to Milewski, issued Feb. 11, 2002; U.S. Pat. No. 6,697,470 to McDonough, issued Beb. 24, 2004; U.S. Pat. No. 6,351,639 to Motohashi, issued Feb. 26, 2002; U.S. Pat. No. 5,999,599 to Shaffer, issued Dec. 7, 1999; U.S. Pat. No. 6,052,438 to Wu, issued Apr. 18, 2000; and U.S. Pat. No. 6,298,132 to Harada, issued Oct. 2, 2001. For communication devices equipped with Caller Identification (CID) or Calling Name Presentation (CNAP) functionality (generally implemented as Calling Number Delivery Service), called parties may also receive the calling number of the calling party in the form of a text based numeric presentation on a display.

Heretofore, however, calling alerts to a calling party have been limited to audible notifications which may not be selected or customized in any way by the called party. Similarly, call alerts to a called party have been limited to audible notifications which may not be selected or customized in any way by the calling party.

Consequently, a need exists for a method and system which permits audible and/or visual call alerts and calling alerts to be customized by calling parties and called parties, respectively. Still further, a need exists for a method and system which permits users to block the aforementioned alerts.

### DISCLOSURE OF INVENTION

It is a principal object of the present invention to provide a method and system for a telephone user to select and customize audible and/or visual functionality of another party's telephone and/or telephone service.

It is a further object of the present invention to provide such a method and system wherein such selection and customization is directed to call termination attempt notifications including call alerts and calling alerts.

It is still further an object of the present invention to provide such a method and system wherein the aforementioned selected call termination attempt notifications, including call alerts and calling alerts may be blocked by called parties and calling parties, respectively.

In carrying out these and other objects, features and advantages of the present invention, there is provided a call notification method and system wherein (1) a calling party may select one of a plurality of audible and/or visual call alerts to be provided with a call to a called party on a call termination attempt by the calling party to the called party in place of the called party's default ringtone; (2) a called party may select one of a plurality of audible and/or visual calling alerts to be provided to a calling party on a call termination attempt by the calling party to the called party in place of the calling party's default ringback; (3) a called party may block an audible and/or visual call alert selected by a calling party to be provided to the called party on a call termination attempt by the calling party; and (4) a calling party may block an audible and/or visual calling alert selected by a called party to be provided to the calling party on a call termination attempt by the calling party.

### BRIEF DESCRIPTION OF DRAWINGS

FIG. 1 is a schematic diagram illustrating a preferred environment for a wireline telecommunications network incorporating the present invention;

FIG. 2 is schematic diagram illustrating a preferred environment for a communication network incorporating the present invention.

FIGS. 3A-3C are flow diagrams illustrating the logic flow of a communication device wherein the method and system of the present invention have been implemented;

FIGS. 4A-4B are flow diagrams illustrating the logic flow of the call termination attempt blocking functionality of the present invention; and

FIGS. 5-8 are flow diagrams of the method steps of the present invention.

### BEST MODE FOR CARRYING OUT THE INVENTION

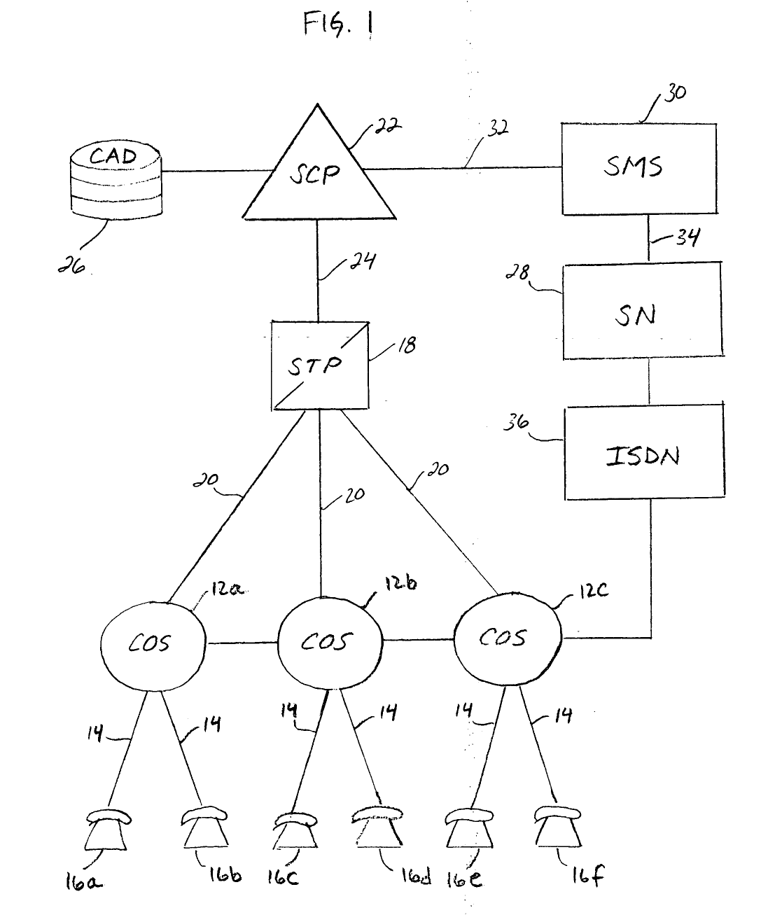

With reference to FIG. 1 of the drawings, there is shown a schematic diagram of a preferred embodiment for a wireline telecommunications network incorporating the present invention which is generally designated by reference numeral 10. As will be described below, the present invention is directed to a system and method for delivery of selected call termination attempt notifications i.e. “call alerts” and/or “calling alerts”. Accordingly, in a preferred embodiment, wireline network 10, also called a “land line” telephone network, may utilize Advanced Intelligent Network (AIN) elements and functionality of a typical Local Exchange Carrier (LEC). It is understood and contemplated by Applicants, however, that any suitable communication network and/or combination of network elements may be used to implement the present invention. Thus the communication network may comprise, for example, the Public Switched Telephone Network (PSTN), the public Internet (also called the “World Wide Web” or WWW) including emerging Voice Over Internet Protocol (VoIP) applications (generally referred to as “Internet Telephony”), as well as any other collection of interconnected computers or termination equipment (e.g. a private internet or “intranet”) which communicate with one another in accordance with a common protocol. Such a protocol may comprise, for example, the Internet Protocol (IP) which specifies the format of packets or “datagrams” and provides an addressing scheme as well as the Transmission Control Protocol (TCP) which may be used to establish a virtual connection at a higher level between a destination and a source. TCP/IP thus establishes a connection between two hosts (computer systems accessed by remote users to obtain data) so as to send and receive messages.

Still referring to FIG. 1, Network 10 in the preferred embodiment illustrated includes a plurality of end or central offices 12a, 12b, and 12c These central offices, which are also referred to as central offices or Central Office Switches (COS) each preferably, but not necessarily, includes a Service Switching Point (SSP) (not shown) or SSP functionality. As those skilled in the art will recognize, a SSP is a switch that includes intelligent network functionality (hardware and/or software) which together function to detect predetermined conditions and initiate corresponding network triggers. For example, an SSP may initiate a trigger for a predetermined state of a call on a subscriber's directory number, generate the trigger in the form of a data query to be sent over the network, and suspend call processing until the SSP receives responsive instructions from the network to take specific action.

As further illustrated in FIG. 1, central offices 12a-c each include a plurality of subscriber lines 14 which, in turn, are each connected to Customer Premises Equipment (CPE) devices (“terminating equipment”) such as telephones 16a, 16b, 16c, 16d, 16e and 16f. Any suitable communication device may, of course be used in place or of in addition to telephones 16a-f including, without limitation, one or more computers or other wired or wireless devices. Each CPE device 16 is assigned a Directory Number. As discussed above, and used herein, the directory number (commonly called the telephone number or calling number) is a unique network address that is assigned to a telephone or other CPE device (and thus the user or subscriber) for routing calls. More simply, the DN is the set of numbers which must be dialed (the digits which must be sent) by a calling party to terminate a call to one or more CPE devices 16 in the network 10. As those skilled in the art will recognize, a call is said to “terminate” when the above digits are sent and a connection is finally made between a calling party and called party following call processing.

Still referring to FIG. 1, each of the central offices 12a-c in network 10 is typically provided in communication with a serving Signal Transfer Point (STP) 18. In the AIN network of the preferred embodiment illustrated, such communication is provided via respective Circuit Signaling System 7 (CCS7) data links 20. A Signal Transfer Point is a switch that provides for the transfer from one signaling link to another. More specifically, in a CCS network such as network 10, herein, STP 18 is a packet switching device that performs a message routing function. More specifically, it functions to receive, discriminate, and transfer CCS7 messages between the signaling points to which it is connected (here central offices 12a-c and SCP 22). Although shown as a separate network element, the STP functionality may, of course, also reside within one or more central offices 12a-c or other suitable network components.

As shown, STP 18 is provided in communication with a Service Control Point (SCP) 22 via a CCS7 link 24. In an intelligent network such as AIN network 10, a service control point implements a service control function and may include one or more subscriber datalogs or databases for identifying network service subscribers as well as the particular services to be provided to such subscribers. A CNAM database is an example of such a subscriber database. The Call Alert Database (CAD) 26 of the present invention is a further example. As discussed below, the call alert database 26 is provisioned to include, by way of a look-up table or other suitable means, relevant information such as calling party name/directory number, called party name/directory number and specified audible and/or visual alerts (call alerts and calling alerts) to be provided to selected called parties and calling parties, respectively. SCP 22 is further provided in communication with a Service Node (SN) 28 via a Service Management System 30 through respective CCS7 data links 32 and 34. Service Management System 30 functions to update the SCP databases (e.g. CAD 26) and other network databases and elements (e.g. Service Node 28).

With reference still to FIG. 1, SN 28 is a network element having computing capability and database maintenance features. Depending on the application, it may also include switching fabric, voice and Dual Tone Multi-Frequency (DTMF) signal recognition functionality as well as voice synthesis functionality and/or devices. As those skilled in the art will recognize, service nodes have similar functionality to service control points (which are time consuming and expensive to modify) and are typically used where a new or enhanced feature is desired to be implemented. Service nodes are thus used when a feature or service requires user interaction or transfer of a significant amount of data to a subscriber over a switch connection. Service nodes are similarly used for implementing services that require real-time communications with a subscriber during a communication. A service node (here SN 28) is typically connected to one or more switches such as central offices 12a-c via an Integrated Services Digital Network (ISDN) link 36.

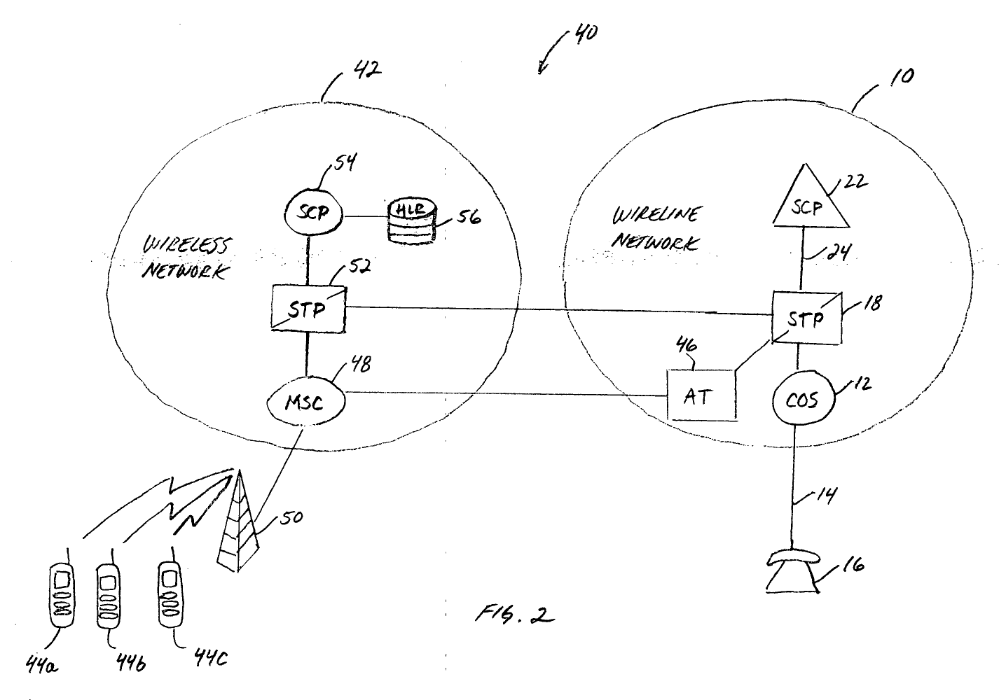

FIG. 2 of the drawings provides a schematic of a communications system designated generally by reference numeral 40 and including a “wireless” or mobile telephone network 42 provided in communication with a wireline network 10 such as that shown and described in FIG. 1 above. Wireline network 10 thus includes one or more end offices or central offices 12 which, as previously discussed, may include SSP functionality or be provided in communication with SSP components. As discussed above, each central office 12 is provided in communication with and serves one or more subscriber lines or telephone lines 14. As shown in FIG. 2, a representative calling line 14 is thus served by central office 12 and is further provided in communication with terminating equipment such as CPE device (“telephone”) 16. Central office 12 is further provided in communication with STP 18 and SCP 22 via CCS7 data links 20 and 24, respectively.

Wireless network 42 may comprise any suitable mobile network such as, for example, a cellular system, a Personal Communications Service (PCS) system, a Global Standard for Mobile communications (GSM) system, a Wireless Intelligent Network (WIN), mesh network, Wireless Fidelity network (Commonly termed Wi-Fi, including, but not limited to, any type of 802.11 network, whether 802.11b, 802.11a, dual-band, etc.), 3g wireless network, 2.5g wireless network, or any or other system wherein radio technology is used in communications. A communication device operating in wireless network 42 may thus comprise and be referred to as a wireless unit, a Wireless Communication Unit (WCU), a mobile phone, a cellular phone, etc. For ease of reference, wireless units 44a, 44b, and 44c of FIG. 2 will be referred to as a mobile telephones.

Still referring to FIG. 2, wireless network 42 may be provided in communication with wireline network 10 in a variety of ways. For exemplary purposes, wireless network 42 is thus shown connected to wireline network 10 through an access tandem 46. As shown, access tandem 46 is provided in communication with a Mobile Switching Center (MSC) 48 (also called a mobile switch) on the wireless side as well as STP 18 and COS 12 on the wireline side. As those skilled in the art will recognize, an MSC performs similar functionality to a wireline network switch by directing communications to and from terminating equipment (here mobile phones 44a, 44b, 44c etc.) An MSC typically stores or has access to information about wireless units operating within an area served by the MSC through a plurality of location registers (not shown) including, for example, a Home Location Register (HLR) and a Visitor Location Register (VLR). An HLR includes information relating to wireless units that are considered “home” units to the MSC. Similarly, a VLR is populated with information relating to wireless units that are visiting i.e. “roaming” in a coverage area of the particular MSC. An MSC such as MSC 48 of FIG. 2 is typically provided in communication with one or more base stations or transceivers 50. Base stations 50 use radio technology to communicate (send and receive voice and data) with wireless units (mobile phones 44a-c) operating within the range of the base station.

Wireless network 42, like wireline network 10, similarly includes an STP 52 which is provided in communication with MSC 48 and an SCP 54. In a wireless network, an SCP is generally an intelligent network element such as an Intellignent Peripheral (IP) which includes service package applications (SPAs), programming, and similar information necessary to implement communication and other services to subscribers. As in the wireline network 10, SCP 54 may also include or have access to databases, tables (e.g. look up tables), or other information relating to subscribers that may be helpful in the implementation of the communications and services. Thus, SCP 54 in wireless network 42 is provided in communication with or includes the functionality of a location register and more particularly a Home Location Register (HLR) 56. The functionality of HLR 56 may also be included in one or more other network elements such as, for example, MSC 48. Regardless whether HLR 56 is implemented as a separate network component or included as functionality in an existing component, it stores information regarding wireless units (here mobile phones 44a-c) that are considered “home” units to MSC 48. Of course, HLR 56 may also include entries for wireless units that are considered “home” units to other MSCs (not shown) as well. Thus, it is anticipated that a single HLR or HLR functionality provided on one or more network components may service multiple MSCs in the wireless network.

As discussed below in further detail, HLR 56 may therefore be provisioned by way of a look-up table or other suitable means to include information necessary for the implementation of the call alert service of the present invention. Such information may include calling party name/directory number, called party name/directory number and specified audible and/or visual alerts (referred to herein as “call alerts” and “calling alerts”) to be provided to selected called parties and/or calling parties.

An exemplary embodiment of the present inventions provides for the storage of or access to call alert programs and/or calling alert programs related to persons and entities associated with selected terminating equipment in both wireless and wireline networks. FIGS. 1 and 2 illustrate preferred embodiments of such networks and include AIN components and functionality. Again, however, it is understood that any suitable network or collection of network components may be utilized, including, without limitation, the Public Switched Telephone Network (PSTN), Integrated Digital Services Network (IDSN), the public Internet and private internets on the wireline side, as well as mesh networks, PCS networks, Wi-Fi networks, etc. on the wireless side.

Provisioning for Calling Party Selected Call Alerts

Wireline Networks

Referring first to FIG. 1 of the drawings, the functionality for delivering call alert information to a called party will be described. As discussed above, FIG. 1 illustrates an exemplary embodiment including a subscriber information database 26 as a preferred source of information. In operation, database 26 may be provisioned (i.e “populated) in advance by a user or subscriber associated with a telephone 16a-f to include selected call alerts such as ringtones or other audible and/or visual alerts to be provided to a called party on a call termination attempt in place of or in addition to a called party's selected or default ringtone. Such call alert information may be provisioned at the time of set up of the calling party termination equipment, on a call by call basis, or any other suitable time. In keeping with the invention and discussed below, it is therefore understood that database 26 may be provisioned by a user (here a calling party) to provide selected call alerts to selected called parties as part of a user's profile.

As an example of such provisioning and operation, assume that a calling party or “user” associated with telephone 16a has provisioned the user's profile to include a selected call alert to be provided to a called party associated with telephone 16e on a call termination attempt. In the example herein described, both parties, of course, are subscribers to a corresponding call alert service which, at the threshold, permits the required call alert provisioning. The calling party 16a begins by placing a call (sending digits) associated with a directory number of the called party. Once the call is placed, a communication is received at the serving central office and or SSP, of the calling party, here central office switch 12a. Central office 12a, and more particularly, an associated SSP or SSP functionality of switch 12a obtains routing information and populates an Initial Address Message (IAM) with selected information. The LAM is a parameter that exists within an Integrated Services Digital Network User Part (ISUP) signaling message. The ISUP signaling message employs a CCS7 call setup protocol. Specifically, the IAM is populated with the calling party directory number and the called party directory number. The details of the query package are well known to those skilled in the art and, accordingly, need not be discussed here in detail.

Central office 12a sends this information in the signaling message to an end office 12c serving telephone 16e and thus the called party associated with telephone 16e. Office 12c recognizes that the call is for a call alert service subscriber and, accordingly, halts or “suspends” call processing and launches a called party alert query on the CCS7 network 10. More specifically, an SSP or the SSP functionality of switch 12c detects a trigger which was set in the SSP in association with the telephone number of telephone 16e (i.e. the called telephone number). The trigger recognizes that the called party subscribes to a call alert service. Alternatively, the calling party may, in addition to dialing the called party directory number, enter a predetermined code or codes (e.g. *xx) which have been specifically provisioned in the above SSP with a call alert service trigger. Regardless of how the SSP trigger is implemented and/or detected, the SSP functions to launch a query (a “called party alert” query) via a serving STP, here STP 18 to an associated network element such as SCP 22, for instructions on how to proceed with the call. More specifically, the SSP populates routing parameters in a suitable query package with routing and code specific information associated with AIN elements and services, as well as directory numbers associated with the calling party 16a and the called party 16e. As part of the query launch, central office 12c populates a called party address parameter in the query with the calling party's directory number. The called party address parameter is a routing parameter within an AIN query package.

Again, the details of the query message are well know to those skilled in the art and need not be discussed here in detail. By way of overview, however, the query package may include parameters such as a Message Transfer Part (MTP) including a routing label consisting of an Originating Point Code (OPC) and a Destination Point Code (DPC). The query package may further include a Signaling Connection Control Part (SCCP) containing a Global Title (calling party address parameter and called party address parameter). Still further, the query package may include a TCAP parameter which is a data field including call data for database services as well as a trigger type which functions to identify the types of triggers detected by the SSP. The TCAP parameter may also include one or more service keys which may be set to specific operations codes which may be sent by a user to initiate a selected service.

After office 12c has populated the called party address parameter, the called party alert query is sent to STP 18. Upon receipt of the above discussed query package (including all relevant routing parameters), STP 18 reformats the package with final routing information. More specifically, STP 18 performs a Global Title Translation (GTT) and changes the DPC of the message so that the query package is routed to the appropriate SCP, here SCP 22. The STP 18 may also change a Subsystem Number (SSN) to enable a specific service package (e.g. the call alert service package) to be accessed within a subsystem of the SCP 22. As those skilled in the art are aware, service package applications are service packages for AIN services which are located within an SCP, here SCP 22, and are capable of processing several communications at the same time. In the preferred embodiment illustrated in FIG. 1, the SSN is changed so that the call alert service of the present invention is accessed when the SCP 22 receives the above query package. Once accessed, the call alert delivery service performs a database look-up via CAD 26 using the calling party telephone number to access the call alert service profile of the calling party. More specifically, the service locates and cross references the called party directory number with a selected call alert. The association between the calling party directory number and/or name and the information corresponding to the call alert preferences for the called party may be accomplished in any suitable way. For example, the calling party directory number or directory name may simply include the information as part of the entry as discussed above. Alternatively, the calling party directory number or directory name may serve as a pointer, flag etc. or include a pointer, flag etc. to another storage medium such as a datalog, database, table or the like. As discussed herein, the user profile may be provisioned and/or updated with such information in advance of the call termination attempt or contemporaneous with the call. Where provisioning is contemporaneous, however, it is understood that additional queries may be required to be launched to request or receive information from the calling party.

In keeping with the invention, after the STP 18 performs the GTT, the query package is sent to the SCP 22. The SCP 22 sends a call alert message to the SSP 12c in a TCAP response. The TCAP response is the final message containing instructions on how to handle the call and ends the SSP/SCP transaction that was initiated with the call alert query. In the example discussed, the TCAP response includes the identification of a specific call alert to be provided to the called party 16e in place of or in addition to the called party's own selected or default ringtone. As discussed above the call alert may comprise any suitable audible or visual alert, including, without limitation, a specified ringtone or other audio clip, video clip, still image, multi-media content, etc. In each case, the call alert message may comprise a corresponding program, code, file, or other information necessary to implement and provide the desired call alert to the called party. For example, where a ringtone has been selected by the calling party, the corresponding program or programs will be identified for access and forwarding. Similarly, where a video clip or still image (e.g. a previously stored digital picture or video of the calling party) has been selected by the calling party, the corresponding files will be identified for access and forwarding. Yet still further, where any of the above selected alerts (and corresponding programs, files, code etc.) may already be resident on the called party's terminating equipment, i.e. CPE device such as telephone 16e, an activation code may be identified and forwarded to the terminating equipment. This information is then routed to the called party 16e when office 12c completes the call and the call alert information is provided to the called party via any suitable audible or visual presentation means such as, for example, a speaker or display device or component associated with the telephone 16e. Such a speaker or display device may be integral with or provided in communication with the terminating equipment.

Wireless Networks

Referring now to FIG. 2 of the drawings, the functionality for delivering call alert information to a called party in a communication system including a wireless network will be described. As discussed above, FIG. 2 illustrates an exemplary embodiment of a communications system 40 including a “wireless” or mobile telephone network 42 provided in communication with a wireline network 10. Wireless network 42 further includes an HLR 56 which is populated with information relating to wireless units 44a-c that are considered “home” units to MSC 48. In operation, HLR 56 may be provisioned in advance by a user or subscriber related to wireless units 44a-c to include selected call alerts such as ringtones or other audible and/or visual alerts to be provided to a called party on a call termination attempt in place of or in addition to a called party's selected or default ringtone. As in the wireline network, such call alert information may be provisioned at the time of set up of the calling party termination equipment, on a call by call basis, or any other suitable time.

In keeping with the invention and discussed below, it is therefore understood that HLR 56 may be provisioned by a user (here a calling party) to provide selected call alerts to selected called parties as part of a user's profile. Such provisioning typically would include at least a Mobile Identity Number (MIN) and/or a Mobile Directory Number (MDN) assigned to the wireless units 44a-c. These entries in HLR 56 may be made by a network administrator or other suitable person upon subscription to and set up of the wireless service.

As an example of such provisioning and operation, assume that a calling party associated with wireless unit 44a of wireless network 42 has provisioned his user profile to include a selected call alert to be provided to a called party associated with telephone 16 of wireline network 10 on a call termination attempt. In the example herein described, both parties, of course, are subscribers to the call alert service which permits the required call alert provisioning. The calling party 44a begins by placing a call (sending digits) associated with a directory number of the called party. Once the call is placed, a communication is received at the serving MSC of the calling party, here MSC 48. The call is thereafter routed in a conventional manner through access tandem 46 whereupon it is received by the serving central office 12 of telephone 16 and, preferably, an associated SSP or SSP functionality of switch 12.

Office 12 recognizes that the call is for a call alert service subscriber and accordingly suspends call processing and launches a called party alert query. More specifically, an SSP or the SSP functionality of switch 12 detects a trigger which was set in the SSP in association with the telephone number of telephone 16. The trigger recognizes that the called party subscribes to a call alert service. Alternatively, the calling party 44a may, in addition to dialing the called party directory number, enter a predetermined code or codes (e.g. *xx) which have been specifically provisioned in the above SSP with a call alert service trigger. Regardless of how the SSP trigger is implemented and/or detected, the SSP uses a suitable messaging process as discussed above in a query/response exchange with the wireless network components, here STP 52, SCP 54 and HLR 56, to obtain instructions on how to proceed with the call. More specifically, the SSP populates routing parameters in a suitable query package with routing and code specific information associated with AIN elements and services, as well as directory numbers associated with the calling party 44a and the called party 16.

Once accessed, the call alert delivery service performs a database look-up via HLR 56 using the calling party telephone number to access the call alert service profile of the calling party. More specifically, the service locates and cross references the called party directory number with a selected call alert. Again, the association between the calling party directory number and/or name and the information corresponding to the call alert preferences for the called party may be accomplished in any suitable way. For example, the calling party directory number or directory name may simply include the information as part of the entry as discussed above. Alternatively, the calling party directory number or directory name may serve as a pointer, flag etc. or include a pointer, flag etc. to another storage medium such as a datalog, database, table or the like. As discussed herein, the user profile may be provisioned and/or updated with such information in advance of the call termination attempt or contemporaneous with the call. Where provisioning is contemporaneous, however, it is understood that additional queries may be required to be launched to request or receive information from the calling party.

As discussed above with reference to the wireline network of FIG. 1, the query package ultimately results in a call alert message which is forwarded to the SSP 12 in a final TCAP response. The TCAP message contains instructions on how to handle the call, including the identification of a specific call alert to be provided to the called party 16 in place of or in addition to the called party's own selected or default ringtone. Again, the call alert may comprise any suitable audible or visual alert, including, without limitation, a specified ringtone or other audio clip, video clip, still image, multi-media content, etc. The call alert message may further comprise a corresponding program, code, file, or other information necessary to implement, activate and provide the desired call alert to the called party. This information is then routed to the called party 16 when office 12 completes the call and the call alert information is provided to the called party via any suitable audible or visual presentation means such as, for example, a speaker or display device. Such a speaker or display device may be integral with or provided in communication with the terminating equipment.

A call within wireless network 42 may be processed in much the same way following a similar call flow. For example, assume that a calling party associated with wireless unit 44a of wireless network 42 has provisioned his user profile to include a selected call alert to be provided to a called party associated with wireless unit 44b of wireless network 42 on a call termination attempt. Again, in the example herein described, both parties are understood to be subscribers to the call alert service which permits the required call alert provisioning. The calling party 44a begins by placing a call (sending digits) associated with a directory number of the called party 44b. Once the call is placed, a communication is received at the serving MSC 48 of the calling party, here MSC 48. The call is thereafter routed in a conventional manner through the wireless network whereupon it is received by the serving MSC of wireless unit 44b. In the example illustrated, wireless units 44a and 44b share the same serving MSC 48. It is understood, however, that in many, if not most instances, parties to the wireless communication will be served by different MSCs.

In keeping with the invention, the serving MSC 48 recognizes that the call is for a call alert service subscriber and accordingly suspends call processing and launches a called party alert query. More specifically, MSC 48 detects a trigger which was set in the MSC in association with the telephone number of telephone 44b. The trigger recognizes that the called party subscribes to a call alert service. Alternatively, the calling party 44a may, in addition to dialing the called party directory number, enter a predetermined code or codes (e.g. *xx) which have been specifically provisioned in the MSC serving the called party with a call alert service trigger. Again, regardless of how the trigger is implemented and/or detected, the MSC 48 uses a suitable messaging process as discussed above in a query/response exchange with STP 52, SCP 54 and HLR 56, to obtain instructions on how to proceed with the call. More specifically, the MSC 48 populates routing parameters in a suitable query package with routing and code specific information as well as directory numbers associated with the calling party 44a and the called party 44b.

Once accessed, the call alert delivery service performs a database look-up via HLR 56 using the calling party telephone number to access the call alert service profile of the calling party. More specifically, the service locates and cross references the called party directory number with a selected call alert.

As discussed above, the query package ultimately results in a call alert message which is forwarded to MSC 48. The message, which may include suitable programming, file or activation information is then routed to the called party 44b when MSC 48 completes the call and the call alert information is provided to the called party via any suitable audible or visual presentation means such as, for example, a speaker or display device. Again, such a speaker or display device may be integral with the wireless unit or provided in communication therewith.

A call placed from the wireline network 10 for delivery to a wireless unit (e.g. 44a) in the wireless network 42 would follow a similar call flow as that described immediately above. In such case, call processing would be suspended by the serving MSC 48 upon detection of a corresponding trigger, whereupon an appropriate message exchange would take place between and among MSC 48 and AIN components of the wireline network 10. The result of the communications would be the location, cross reference and forwarding of a selected call alert, and more particularly, corresponding programming, file or activation information stored in a subscriber information database such as a CAD 26 to the called party 44a.

Provisioning for Called Party Selected Calling Alerts

Wireline Networks

Referring again to FIG. 1 of the drawings, the functionality for delivering calling alert information to a calling party will be described. As discussed above, FIG. 1 illustrates an exemplary embodiment including a subscriber information database 26 as a preferred source of information. In operation, database 26 may be provisioned (i.e “populated”) in advance by a user or subscriber related to a telephone 16a-f to include selected calling alerts such as ringbacks or other audible and/or visual alerts to be provided to a calling party on a call termination attempt in place of or in addition to a calling party's selected or default ringback. Such calling alert information may be provisioned at the time of set up of the called party termination equipment, on a call by call basis, or any other suitable time. In keeping with the invention and discussed below, it is therefore understood that database 26 may be provisioned by a user (here a called party) to provide selected calling alerts to selected calling parties as part of a user's profile.

As an example of such provisioning and operation, assume that a called party or “user” associated with telephone 16e has provisioned the user's profile to include a selected calling alert to be provided to a calling party associated with telephone 16a on a call termination attempt. In the example herein described, both parties, of course, are subscribers to a corresponding calling alert service which, at the threshold, permits the required calling alert provisioning. The calling party 16a begins by placing a call (sending digits) associated with a directory number of the called party. Once the call is placed, a communication is received at the serving central office and or SSP, of the calling party, here central office switch 12a. Central office 12a, and more particularly, an associated SSP or SSP functionality of switch 12a obtains routing information and populates an Initial Address Message (IAM) with selected information. Again, as indicated above, the LAM is a parameter that exists within an Integrated Services Digital Network User Part (ISUP) signaling message. Specifically, the IAM is populated with the calling party directory number and the called party directory number.

Central office 12a sends this information in the signaling message to an end office 12e serving telephone 16e and thus the called party associated with telephone 16e. Office 12e recognizes that the call is for a calling alert service subscriber and, accordingly, halts or “suspends” call processing and launches a called party alert query on the CCS7 network 10. More specifically, an SSP or the SSP functionality of switch 12e detects a trigger which was set in the SSP in association with the telephone number of telephone 16e (i.e. the called telephone number). The trigger recognizes that the called party subscribes to a calling alert service. Regardless of how the SSP trigger is implemented and/or detected, the SSP functions to launch a query (a “calling party alert” query) via a serving STP, here STP 18 to an associated network element such as SCP 20, for instructions on how to proceed with the call. More specifically, the SSP populates routing parameters in a suitable query package with routing and code specific information associated with AIN elements and services, as well as directory numbers associated with the calling party 16a and the called party 16e. As part of the query launch, central office 16e populates a called party address parameter in the query with the calling party's directory number.

After office 12e has populated the called party address parameter, the calling party alert query is sent to STP 18. Upon receipt of the above discussed query package (including all relevant routing parameters), STP 18 reformats the package with final routing information. More specifically, STP 18 performs a Global Title Translation (GTT) and changes the DPC of the message so that the query package is routed to the appropriate SCP, here SCP 22. The STP 18 may also change a Subsystem Number (SSN) to enable a specific service package (e.g. the calling alert service package) to be accessed within a subsystem of the SCP 22. In the preferred embodiment illustrated in FIG. 1, the SSN is changed so that the calling alert service of the present invention is accessed when the SCP 22 receives the above query package. Once accessed, the calling alert delivery service performs a database look-up via CAD 26 using the called party telephone number to access the calling alert service profile of the called party. More specifically, the service locates and cross references the calling party directory number with a selected calling alert. The association between the called party directory number and/or name and the information corresponding to the calling alert preferences for the calling party may be accomplished in any suitable way. For example, the called party directory number or directory name may simply include the information as part of the entry as discussed above. Alternatively, the called party directory number or directory name may serve as a pointer, flag etc. or include a pointer, flag etc. to another storage medium such as a datalog, database, table or the like.

In keeping with the invention, after the STP 18 performs the GTT, the query package is sent to the SCP 22. The SCP 20 sends a calling alert message to the SSP 12a in a TCAP response. The TCAP response is the final message containing instructions on how to handle the call and ends the SSP/SCP transaction that was initiated with the call alert query. In the example discussed, the TCAP response includes the identification of a specific calling alert to be provided to the calling party 16a in place of or in addition to the calling party's own selected or default ringback. As discussed above the calling alert may comprise any suitable audible or visual alert, including, without limitation, a specified ringback or other audio clip, video clip, still image, multi-media content, etc. In each case, the calling alert message may comprise a corresponding program, code, file, or other information necessary to implement and provide the desired calling alert to the calling party. For example, where a ringback has been selected by the called party, the corresponding program or programs will be identified for access and forwarding. Similarly, where a video clip or still image (e.g. a previously stored digital picture or video of the called party) has been selected by the called party, the corresponding files will be identified for access and forwarding. Yet still further, where any of the above selected alerts (and corresponding programs, files, code etc.) may already be resident on the calling party's terminating equipment, i.e. CPE device such as telephone 16a, an activation code may be identified and forwarded to the terminating equipment. This information is then routed to the calling party 16a when office 12a completes the call and the calling alert information is provided to the calling party via any suitable audible or visual presentation means such as, for example, a speaker or display device or component. Such a speaker or display device may be integral with or provided in communication with the terminating equipment.

Wireless Networks

Referring again to FIG. 2 of the drawings, the functionality for delivering calling alert information to a calling party in a communication system including a wireless network will be described. As discussed above, FIG. 2 illustrates an exemplary embodiment of a communications system 40 including a “wireless” or mobile telephone network 42 provided in communication with a wireline network 10. Wireless network 42 further includes an HLR 56 which is populated with information relating to wireless units 44a-c that are considered “home” units to MSC 48. In operation, HLR 56 may be provisioned in advance by a user or subscriber related to wireless units 44a-f to include selected calling alerts such as ringbacks or other audible and/or visual alerts to be provided to a calling party on a call termination attempt in place of or in addition to a called party's selected or default ringback. As in the wireline network, such call alert information may be provisioned at the time of set up of the called party termination equipment, on a call by call basis, or any other suitable time.

In keeping with the invention and discussed below, it is therefore understood that HLR 56 may be provisioned by a user (here a called party) to provide selected calling alerts to selected calling parties as part of a user's profile. Such provisioning typically would include at least a Mobile Identity Number (MIN) and/or a Mobile Directory Number (MDN) assigned to the wireless unit 44a-c. These entries in HLR 56 may be made by a network administrator or other suitable person upon subscription to the wireless service.

As an example of such provisioning and operation, assume that a user or prospective “called party” associated with telephone 16a of wireline network 10 has provisioned his user profile to include a selected calling alert to be provided to a calling party associated with wireless unit 44a of wireless network 42 on a call termination attempt. In the example herein described, both parties, of course, are subscribers to the calling alert service which permits the required calling alert provisioning. The calling party 44a begins by placing a call (sending digits) associated with a directory number of the called party 16. Once the call is placed, a communication is received at the serving MSC of the calling party, here MSC 48. The call is thereafter routed in a conventional manner through access tandem 46 whereupon it is received by the serving central office 12 of telephone 16 and, more particularly, an associated SSP or SSP functionality of switch 12.

Office 12 recognizes that the call is for a calling alert service subscriber and accordingly suspends call processing and launches a calling party alert query. More specifically, an SSP or the SSP functionality of switch 12 detects a trigger which was set in the SSP in association with the telephone number of telephone 16. The trigger recognizes that the calling party subscribes to a calling alert service. The SSP uses a suitable messaging process as discussed above in a query/response exchange with the wireless network components, here STP 52, SCP 54 and HLR 56, to obtain instructions on how to proceed with the call. More specifically, the SSP populates routing parameters in a suitable query package with routing and code specific information associated with AIN elements and services, as well as directory numbers associated with the calling party 44a and the called party 16.

Once accessed, the calling alert delivery service performs a database look-up via HLR 56 using the called party telephone number to access the calling alert service profile of the called party. More specifically, the service locates and cross references the calling party directory number with a selected calling alert. Again, the association between the calling party directory number and/or name and the information corresponding to the calling alert preferences for the called party may be accomplished in any suitable way.

As discussed above with reference to the wireline network of FIG. 1, the query package ultimately results in a calling alert message which is forwarded to the SSP 12 in a final TCAP response. The TCAP message contains instructions on how to handle the call, including the identification of a specific calling alert to be provided to the calling party 44a in place of or in addition to the calling party's own selected or default ringback. Again, the calling alert may comprise any suitable audible or visual alert, including, without limitation, a specified ringtone or other audio clip, video clip, still image, multi-media content, etc. The calling alert message may further comprise a corresponding program, code, file, or other information necessary to implement, activate and provide the desired calling alert to the calling party. This information is then routed to the calling party 44a when office 12 completes the call and the calling alert information is provided to the calling party via any suitable audible or visual presentation means such as, for example, a speaker or display device. Such a speaker or display device may be integral with or provided in communication with the terminating equipment.

A call within wireless network 42 may be processed in much the same way following a similar call flow. For example, assume that a user or “called party” associated with wireless unit 44b of wireless network 42 has provisioned his user profile to include a selected calling alert to be provided to a calling party associated with wireless unit 44a of wireless network 42 on a call termination attempt. Again, in the example herein described, both parties are understood to be subscribers to the calling alert service which permits the required calling alert provisioning. The calling party 44a begins by placing a call (sending digits) associated with a directory number of the called party 44b. Once the call is placed, a communication is received at the serving MSC of the calling party, here MSC 48. The call is thereafter routed in a conventional manner through the wireless network whereupon it is received by the serving MSC of wireless unit 44b. In the example illustrated, wireless units 44a and 44b share the same serving MSC 48. It is understood, however, that in many, if not most instances, parties to the wireless communication will be served by different MSCs.

In keeping with the invention, the serving MSC recognizes that the call is for a calling alert service subscriber and accordingly suspends call processing and launches a calling party alert query. More specifically, MSC detects a trigger which was set in the MSC in association with the telephone number of telephone 44b. The trigger recognizes that the called party subscribes to a calling alert service. The MSC uses a suitable messaging process as discussed above in a query/response exchange with STP 52, SCP 54 and HLR 56, to obtain instructions on how to proceed with the call. More specifically, the MSC populates routing parameters in a suitable query package with routing and code specific information as well as directory numbers associated with the calling party 44a and the called party 44b.

Once accessed, the calling alert delivery service performs a database look-up via HLR 56 using the called party telephone number to access the calling alert service profile of the called party. More specifically, the service locates and cross references the calling party directory number with a selected calling alert.

As discussed above, the query package ultimately results in a calling alert message which is forwarded to MSC 48. The message, which may include suitable programming, file or activation information is then routed to the calling party 44a when MSC 48 completes the call and the calling alert information is provided to the calling party via any suitable audible or visual presentation means such as, for example, a speaker or display device. Again, such a speaker or display device may be integral with the wireless unit or provided in communication therewith.

A call placed from the wireline network 10 for delivery to a wireless unit (e.g. 44a) in the wireless network 42 would follow a similar call flow as that described immediately above. In such case, call processing would be suspended by the serving MSC 48 upon detection of a corresponding trigger, whereupon an appropriate message exchange would take place between and among MSC 48 and AIN components of the wireline network 10. The result of the communications would be the location, cross reference and forwarding of a selected calling alert, and more particularly, corresponding programming, file or activation information stored in a subscriber information database such as a CAD 26 to the called party 44a.

As will be understood by those skilled in the art, the aforementioned call alerts and calling alerts (whether ringbacks or ringtones, audio, text, still image or video) may be stored as computer programs or other suitable instructions, files or code which function to tell a corresponding processing unit in the communication device (not shown) what the communication device should do when the device receives or makes a call termination attempt. Such information may accordingly be stored in whole or in part in a suitable memory element or elements of the communication device and/or corresponding network elements. Similarly, the information may be processed in a suitable processor or processing unit or units such as a CPU in the communication device or in combination with additional network elements or other communication devices having appropriate processing functionality. As discussed herein, such processing may comprise selection and provision of the selected program, file etc. to a called or calling party as the desired call notification (i.e. call alert or calling alert). Still further, processing in accordance with the invention may comprise user blocking of a notification selected by a sending party.

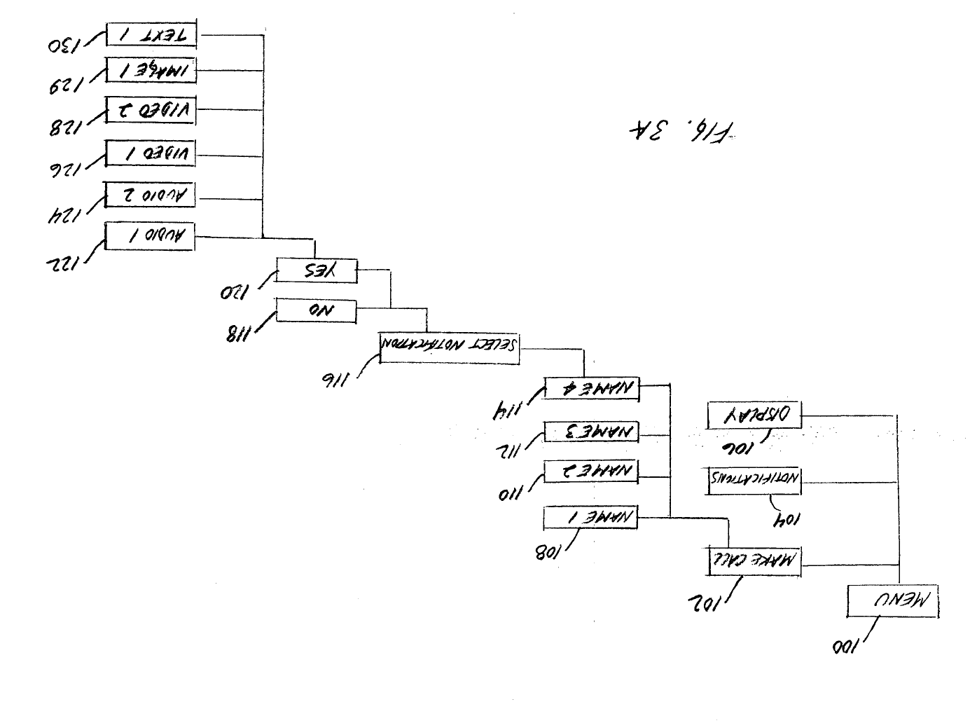

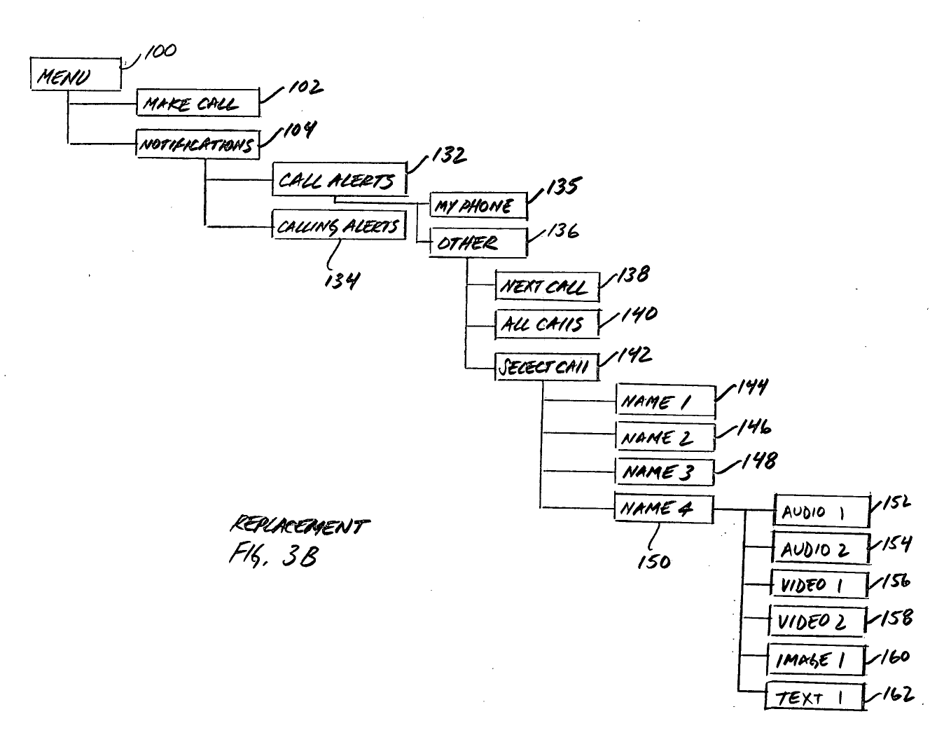

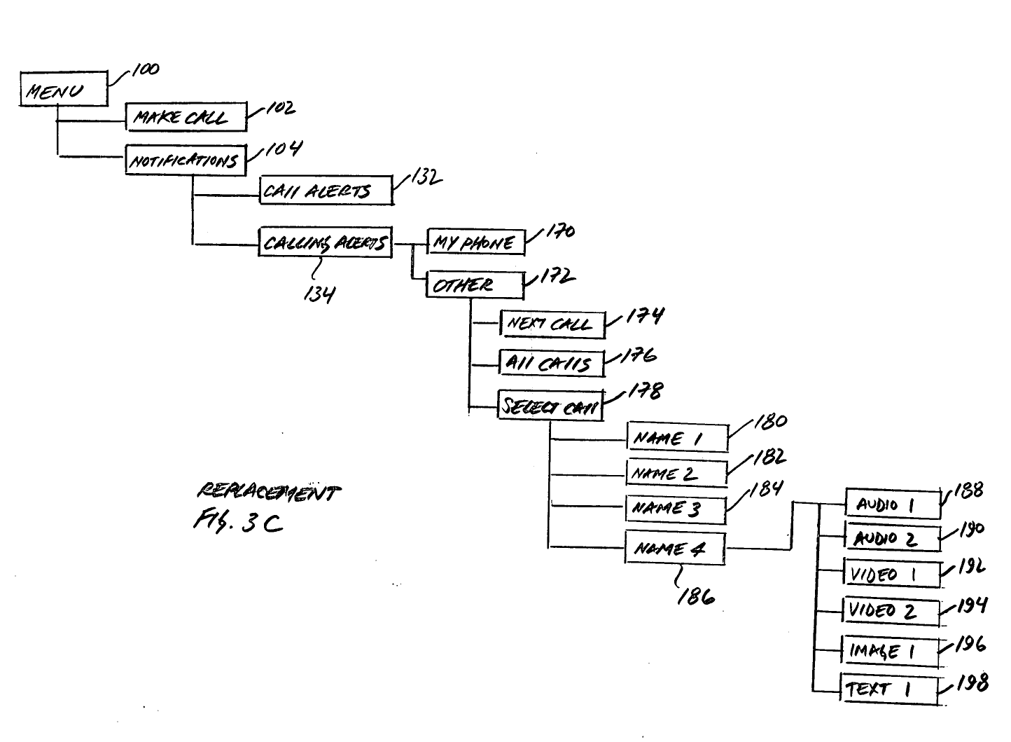

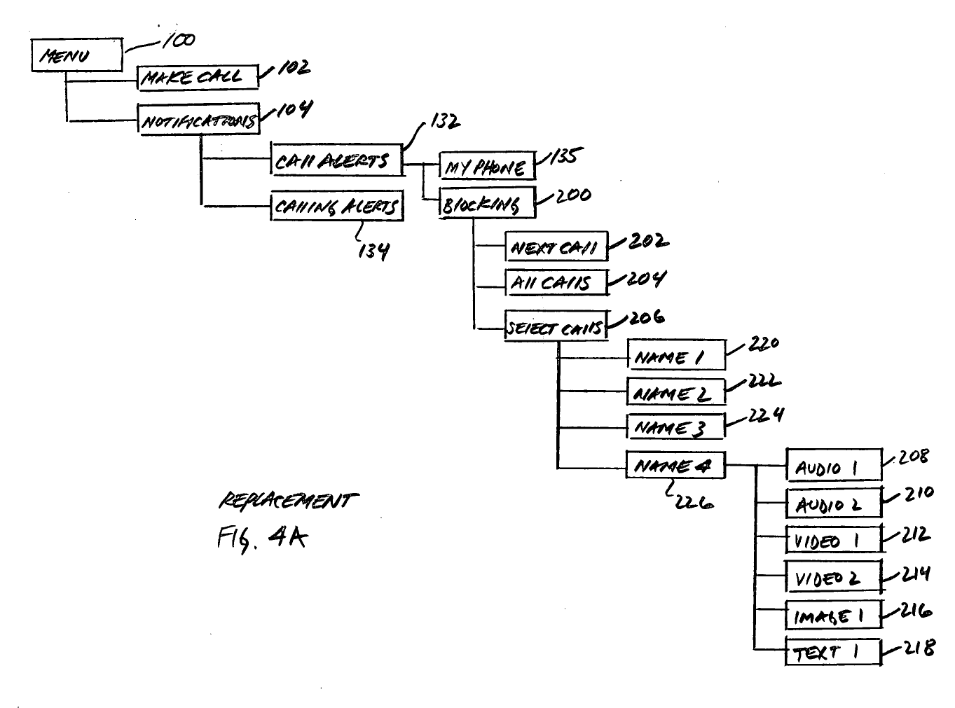

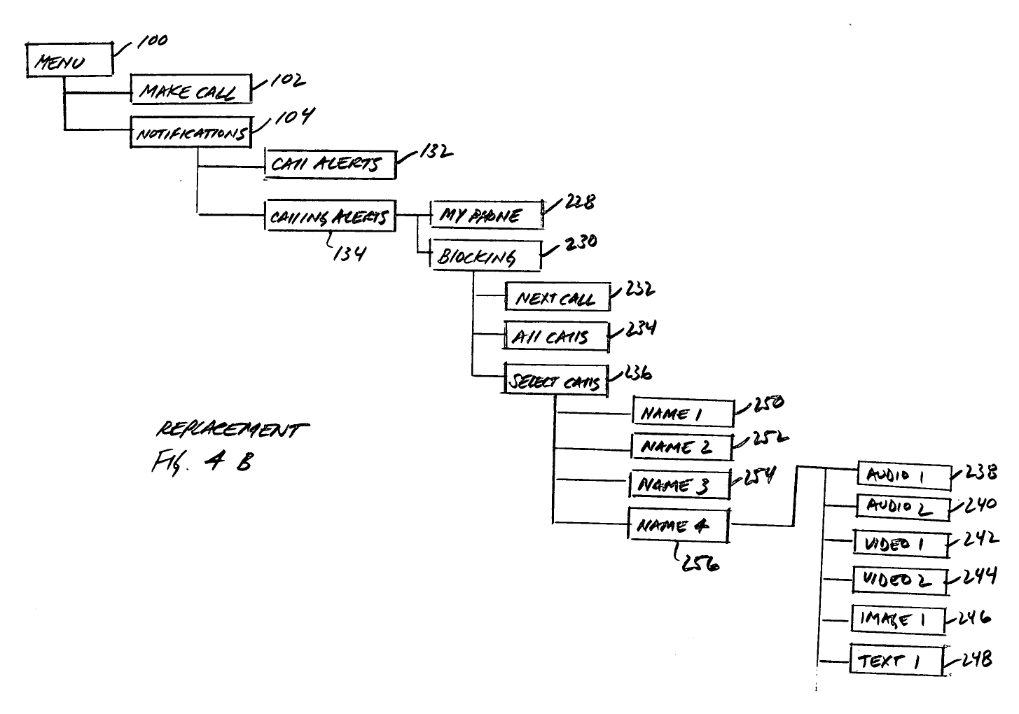

As will be described with reference to the logic diagrams of FIGS. 3-4 below, regardless of the storage and/or processing locations, the corresponding programs may be selected and directed for playback/blocking at the desired communication device. Where the program itself is already resident on the desired device (for example, pre-loaded at the time of manufacture, or otherwise obtained), the program need only be activated (or inactivated) for the desired call. Where the program is not resident on the desired device, the method and system of the present invention functions to forward or block the program or programs or other suitable instructions or code to the desired device whereupon it is likewise activated as the requested call termination notification (or blocked in accordance with the user's request).

Turning now to FIGS. 3A-3B of the drawings, there will now be described in detail the process of selecting and customizing a desired call termination attempt notification of the present invention. As shown in FIG. 3A, a user communication device such as, for example, a mobile telephone 44 of FIG. 2 or communication device 12 of FIG. 1 will generally provide the user a Graphical User Interface (GUI) which functions to receive user input. Such input selections may include, for example, <MENU> 100. <MENU> selection 100 may further include sub-selections such as <MAKE CALL> 102, <NOTIFICATIONS> 104, <DISPLAY> 106, etc. <MAKE CALL> selection 102 may further include the ability to scroll through stored names, e.g. <NAME 1> 108, <NAME 2> 110, <NAME 3> 112, <NAME 4> 114, etc. each of which has been pre-programmed in the communication device by the user or otherwise stored in a network element for recall by the user and which further corresponds to a stored telephone number. Upon selection of a stored name to call, e.g. <NAME 4> 114, the user may further be provided a sub-selection, among others, to <SELECT NOTIFICATION> 116. A further selection of <YES> 120 provides the user the ability to select from one or more of a plurality of audible and/or visual call alerts as shown by the designations <AUDIO 1> 122, <AUDIO 2> 124, <VIDEO 1> 126, <VIDEO 2> 128, <IMAGE 1> 129, <TEXT 1> 130, etc.

The programs corresponding to the selected call alerts may be stored in the communication device (CPE 12 or handset 44), any suitable network element such as, for example, a database or datalog or Switching Transfer Point (STP) of an Advanced Intelligent Network (AIN) or other Intelligent Peripheral (IP), as well as the called party's communication device itself. For example, as indicated above, a plurality of selectable ringtones (e.g. <AUDIO 1> 122 and <AUDIO 2> 124) may be stored in a called party's handset at the time of manufacture. Such ringtones may, accordingly, be selected by a calling party as described above in addition to any such selection and/or customization provided to the called party as party of his or her own telephone feature set. Similarly, a plurality of images such as digital pictures may be taken and/or stored at the time of manufacture or later in the calling party's handset. Still further, the foregoing plurality of ringtones, images, etc may be selectable by the user through communication with the network or one or more network elements or services. Thus, it is understood that the network will search appropriately and forward and/or activate the corresponding instructions as necessary to forward the desired notification to the called party on the call termination attempt.

The foregoing discussion has been directed to the situation wherein a user (a calling party 12 or 44) is provided the ability to select a desired notification for a called party at the time of making a call. There will now be described with reference to FIGS. 3B-3C, the process wherein (a) a calling party may select in advance a notification to be provided to a selected called party on a call termination attempt; and (b) a called party may select in advance a notification to be provided to a selected calling party on a call termination attempt. As shown, a Graphical User Interface (GUI) or other suitable display may provide the user as sub-selections to <NOTIFICATIONS> 104, <CALL ALERT> 132 and <CALLING ALERT> 134. Of course, any suitable labels may be used. Thus, where only audio notifications are anticipated, the labels “RINGTONES” and “RINGBACKS” might be used with greater accuracy.

Referring still to FIG. 3B and the label <CALL ALERT> 132, the user may further be provided sub-selections <MY PHONE> 135 and <OTHER> 136. <MY PHONE> 135, of course, permits the user the ability to select and customize his or her own call termination attempt notifications from calling parties (e.g. ringtones, photo ID, etc wherein the user is the called party). <OTHER> 136, in contrast, and keeping with the invention described herein, permits the user the ability to select and customize in advance the notifications to selected called parties.

As shown, sub-selection <OTHER> 136 may further provide the user additional sub-selections <NEXT CALL> 138 wherein the user may select and customize the call notification (e.g. ringtone) of the next call made, <ALL CALLS> 140, wherein the user may select and set a default notification for all called parties, and/or <SELECT CALL> 142 wherein the user may select and customize in advance the desired call notification for a selected called party. A sub-selection for <SELECT CALL> 142, may include, for example, the ability for the user to scroll through and select from a plurality of stored names and corresponding telephone numbers as described above with reference to the <MAKE CALL> selection 102. The difference being, however, that in the present example, no current telephone call is being made to a called party. For example, the user (calling party) may select from <NAME 1> 144, <NAME 2> 146, <NAME 3> 148, <NAME 4> 150 etc. each of which has been pre-programmed by the user in the communication device or otherwise stored in a network element for recall by the user.

Once the desired name is located and selected, the user will similarly be provided a plurality of sub-selections corresponding to available audible and/or visual call alerts such as <AUDIO 1> 152, <AUDIO 2> 154, <VIDEO 1> 156, <VIDEO 2> 158, <IMAGE 1> 160, <TEXT 1> 162, etc shown and referred to above. Again, the programs, text, images, files, etc. corresponding to the selected call alerts may be stored in the user's (calling party's) communication device, any suitable network element, or the called party's communication device such that the network will be required to locate, and forward and/or activate the corresponding information at the time of making a corresponding call from the user to the designated called party.

In keeping with the invention, it is understood that suitable sub-selections for <NEXT CALL> 138 and <ALL CALLS> 140 of the foregoing illustration will follow a similar logic flow for selection of a desired call attempt notification

Referring to FIG. 3C, a selection of a desired calling alert for a calling party is made in much the same way as described with reference to ringtones. Thus, the selection <CALLING ALERT> 134 may similarly include as sub-selections <MY PHONE> 170 and <OTHER> 172. Again, <MY PHONE> 170, permits the user the ability to select and customize his or her own call termination attempt notifications (e.g. ringbacks). <OTHER> 172, in contrast, and keeping with the invention described herein, permits the user the ability to select and customize in advance the notifications of selected calling parties such as CPE 12 and mobile telephone 44 described above in FIGS. 1 and 2.

As shown, sub-selection <OTHER> 172 may therefore further provide the user additional sub-selections <NEXT CALL> 174 wherein the user (a called party) may select and customize the calling alert of the next calling party, <ALL CALLS> 176, wherein the user may select and set a default calling alert for all calling parties, and/or <SELECT CALL> 178 wherein the user may select and customize in advance the desired calling alert for a selected calling party. A sub-selection for <SELECT CALL> 178, may similarly include, for example, the ability for the user to scroll through and select from a plurality of stored names and corresponding telephone numbers as described above with reference to the <MAKE CALL> selection 102. Again, the difference being, however, that in the present example, no current telephone call is being made or received. Thus, the user may select from <NAME 1> 180, <NAME 2> 182, <NAME 3> 184, <NAME 4> 186 etc. each of which has been pre-programmed by the user (the called party) in the communication device or otherwise stored in a network element for recall by the user.

Once the desired name is located and selected, the user will similarly be provided a plurality of sub-selections corresponding to available audible and/or visual call alerts such as <AUDIO 1> 188, <AUDIO 2> 190, <VIDEO 1> 192, <VIDEO 2> 194, <IMAGE 1> 196, <TEXT 1> 198, etc shown and referred to above. Again, the programs corresponding to the selected call alerts may be stored in the user's (called party's) communication device, any suitable network element, or the calling party's communication device such that the network will be required to locate, and forward and/or activate the corresponding instructions at the time of receiving a corresponding call to the user from the designated calling party.

In keeping with the invention, it is understood that suitable sub-selections for <NEXT CALL> 174 and <ALL CALLS> 176 of the foregoing illustration of calling alert selection will follow a similar logic flow for selection of a desired call attempt notification

Again, as discussed above, and in keeping with the invention, it is understood that the above described selectable “call alerts” and “calling alerts”, referred to generally as call termination attempt notifications, may comprise any suitable audible or visual call alert including, without limitation, an audio tone or series of audio tones, still image, video clip, song, tune, text message, multi-media clip or any combination of the foregoing which function to selectively alert a called party or a calling party of a call termination attempt as selected by the opposing party.

In further keeping with the invention, there is disclosed herein, a method and system for blocking the above referenced call notifications. More specifically, such a method and system is directed to permit a calling party to block any or all call alert (e.g. ringtone) selections made by a called party. Still further, the method and system is directed to permit a calling party to block any or all calling alert (e.g. ringback) selections made by a called party.

As discussed above, the ability of a calling party to select a called party's call alert (e.g. ringtone) and the ability of a called party to select a calling party's calling alert (e.g. ringback) permits users to distinguish and personalize their calling experience. Such personalization, however, may sacrifice the privacy of the receiving party. Accordingly, the present invention further permits intended recipients the ability to block any or all such selections. Such blocking may be provided, for example, by a default telephone/network setting which rejects receipt and/or activation of any call programs from third parties including, ringbacks and ringtones whether resident on the user's communication device or within a network element. Still further, such a method and system may block selected programs by category or specific identification. Yet still further, the method and system may block all programs not previously approved by the user.

Referring to FIGS. 4A and 4B of the drawings, there will now be described in detail the process of selecting and customizing a desired block of call termination attempt notifications. As discussed above, a user communication device such as, for example, a mobile telephone 44 of FIG. 2 or CPE device 16 of FIG. 1 will generally provide the user a Graphical User Interface (GUI) which functions to receive user input. Such input selections may include, for example, <MENU> 100. <MENU> selection 100 may further include sub-selections such as <MAKE A CALL> 102, <NOTIFICATIONS> 104 etc. The GUI may provide the user as sub-selections to <NOTIFICATIONS> 104, <CALL ALERTS> 132 and <CALLING ALERTS> 134. Referring first to FIG. 4A and <CALL ALERTS> 132, the user may further be provided the sub-selection <MY PHONE> 135 which permits the user the ability to select and customize his or her own call alerts (e.g. ringtones). In keeping with the invention, however, <MY PHONE> 78 may further provide the user the ability to “block” selected call alerts which may be selected by a calling party. Thus, <MY PHONE> 135 may provide the additional sub-selection <BLOCK> 200 which, in turn, may provide additional selections such as <NEXT CALL> 202, <ALL CALLS> 204 or <SELECT CALL> 206. In each case, a further sub-selection of available call notifications may be selected for blocking such as <AUDIO 1> 208, <AUDIO 2> 210, <VIDEO 1> 212, <VIDEO 2> 214, <IMAGE 1> 216, <TEXT 1> 218, etc In the case of <SELECT CALL> 206, an additional name scrolling step may also be provided wherein the user may first select a stored name (and corresponding number) e.g. <NAME 1> 220, <NAME 2> 222, <NAME 3> 24, <NAME 4> 226 etc. for which one or more specific notifications may be blocked.

Where one or more notifications are selected for blocking either the CPE device or mobile communication device alone or in conjunction with network intelligence will block all corresponding call programs and/or code from being received and/or activated for the user on the selected calls. In such manner, the user (a called party) may prevent any and all unauthorized call termination attempt notifications from being implemented on the user's telephone without the user's consent.

Referring to FIG. 4B of the drawings, user blocking of called party selected notification may also be achieved in the same manner as discussed above. Thus, mobile telephone 44 of FIG. 2 or CPE device 16 of FIG. 1 will generally provide the user a Graphical User Interface (GUI) which functions to receive user input. As discussed above, such input selections may include, for example, <MENU> 100. <MENU> selection 100 may further include sub-selections such as <MAKE A CALL> 102, <NOTIFICATIONS> 104 etc. The GUI may provide the user as sub-selections to <NOTIFICATIONS> 104, <CALL ALERTS> 132 and <CALLING ALERTS> 134. Referring now to <CALLING ALERTS> 134, the user may further be provided the sub-selection <MY PHONE> 228 which, of course, permits the user the ability to select and customize his or her own ringbacks. In keeping with the invention, however, <MY PHONE> 228 may further provide the user the ability to “block” selected calling alerts which may be selected by a called party. Thus, <MY PHONE> 228 may provide the additional sub-selection <BLOCK> 230 which, in turn, may provide additional selections such as <NEXT CALL> 232, <ALL CALLS> 234 or <SELECT CALL> 236. In each case, a further sub-selection of available call notifications may be selected for blocking such as <AUDIO 1> 238, <AUDIO 2> 240, <VIDEO 1> 242, <VIDEO 2> 244, <IMAGE 1> 246, <TEXT 1> 248, etc In the case of <SELECT CALL> 156, an additional name scrolling step as discussed above may also be provided wherein the user may first select a stored name (and corresponding number) for which one or more specific calling alerts may be blocked as shown be reference numerals 250-256, respectively.

Where one or more notifications are selected for blocking either the CPE device or mobile communication device alone or in conjunction with network intelligence will block all corresponding call programs from being received and/or activated for the user on the selected calls. In such manner, the user (here a calling party) may prevent any and all unauthorized calling alerts i.e. ringbacks from being implemented on the user's telephone without the user's consent.

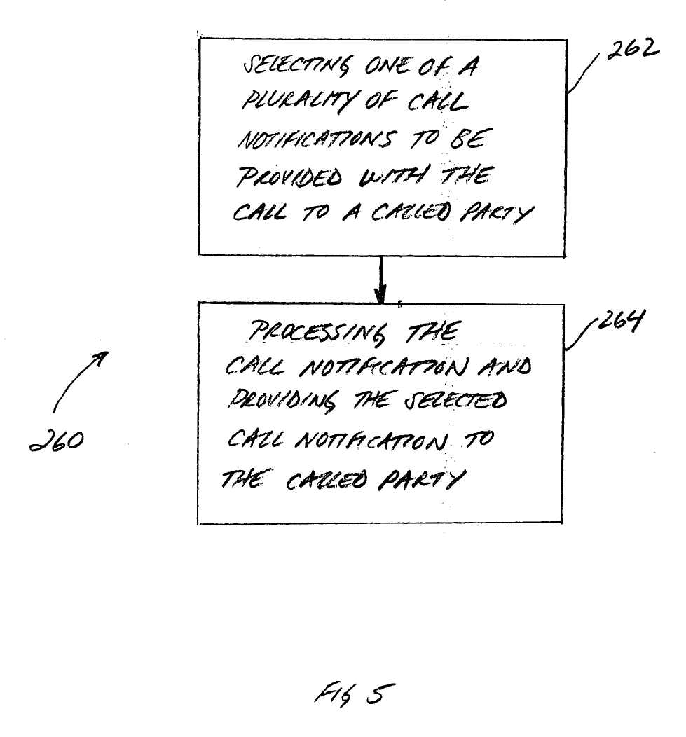

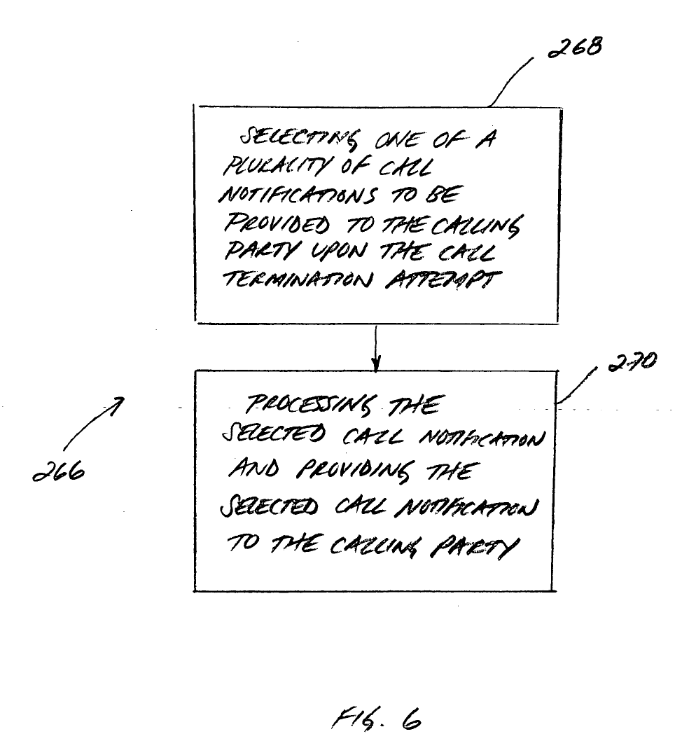

Turning now to FIGS. 5-8, there is illustrated flow diagrams of the method steps of the present invention. As shown in FIG. 5, and designated generally be reference numeral 260, the method is specifically directed for use in a communication network for a calling party to provide a selected call notification to a called party upon a call termination attempt. The method comprises selecting 262 one of a plurality of call notifications to be provided with the call to the called party. The method further comprises processing 264 the selected call notification and providing the selected call notification to the called party. As shown in FIG. 6 and designated generally by reference numeral 266, the method is further directed for use in a communication network for a called party to provide a selected call notification to a calling party upon a call termination attempt. Accordingly, the method comprises selecting 268 one of a plurality of call notifications to be provided to the calling party upon the call termination attempt. The method further comprises processing 270 the selected call notification and providing the selected calling notification to the calling party.

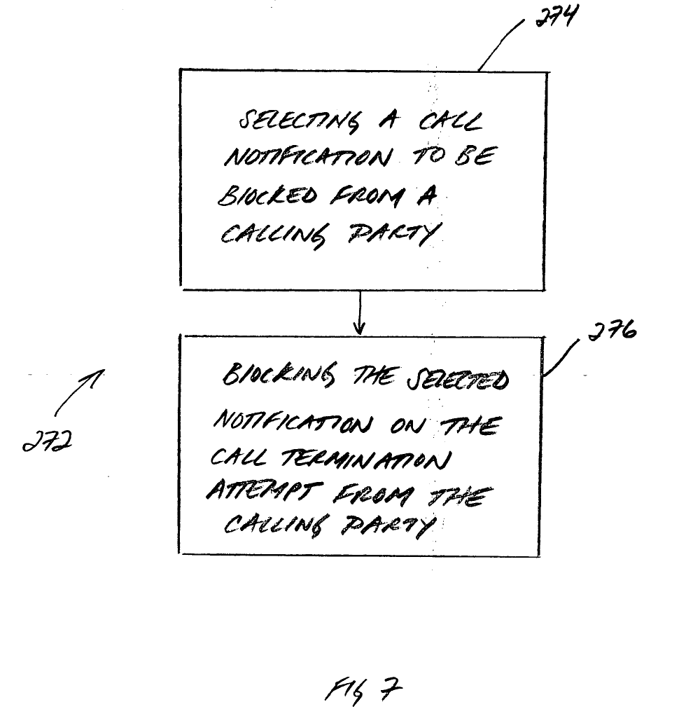

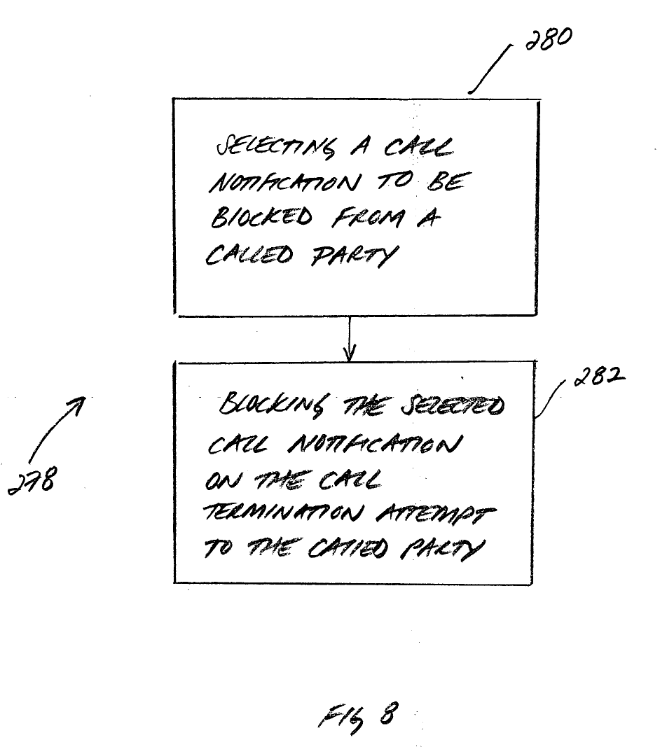

Still further, as shown in FIG. 7 and designated generally by reference numeral 272, the method is directed to providing a called party the ability to block a call notification selected by a calling party. The method comprises selecting 274 a call notification to be blocked from a calling party and blocking 276 the selected notification on the call termination attempt from the calling party. Yet still further, as show in FIG. 8 and designated generally by reference numeral 278, the method is directed to providing a calling party the ability to block a call notification selected by a called party. The method comprises selecting 280 a call notification to be blocked from a called party and blocking 282 the selected call notification on the call termination attempt to the called party.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A call alert system implemented as a call alert service to a calling party by a telephone service provider, the calling party wishing to have a particular call alert provided to a called party upon a call termination attempt by the calling party, the call alert system comprising:
selection means for the calling party to select one of a plurality of call alerts to be provided with the call to the called party; and
processing means for providing the selected call alert to the called party on the call termination attempt.

2. A call alert system as in claim 1, wherein the plurality of call alerts comprise ringtones.

3. A call alert system as in claim 1, wherein the plurality of call alerts comprise audio clips.

4. A call alert system as in claim 1, wherein the plurality of call alerts comprise video clips.

5. A call alert system as in claim 1, wherein the plurality of call alerts comprise digital pictures.

6. A ringtone system implemented as a ringtone service to a calling party by a telephone service provider, comprising:
selection means for the calling party to select one of a plurality of ringtones to be provided with a call to a called party; and
processing means for providing the selected ringtone to the called party on a call termination attempt to the called party.

7. A communication device, comprising:
a controller for a calling party to select one of a plurality of call alerts to be provided with a call to a called party upon a call termination attempt; and
a processor for providing the selected call alert to the called party.

8. A communication device as in claim 7, wherein the device is wireless.

9. A calling alert system implemented as a calling alert service to a called party by a telephone service provider, the called party wishing to have a particular calling alert provided to a calling party upon a call termination attempt to the called party, the calling alert system comprising:
selection means for the called party to select one of a plurality of calling alerts to be provided to the calling party; and
processing means for providing the selected calling alert to the calling party on the call termination attempt.

10. A calling alert system as in claim 9, wherein the plurality of calling alerts comprise ringtones.

11. A calling alert system as in claim 9, wherein the plurality of calling alerts comprise audio clips.

12. A calling alert system as in claim 9, wherein the plurality of calling alerts comprise video clips.

13. A calling alert system as in claim 9, wherein the plurality of calling alerts comprise digital pictures.

14. A communication device, comprising:
a controller for a called party to select one of a plurality of calling alerts to be provided to a calling party upon a call termination attempt to the called party; and
a processor for providing the selected calling alert to the calling party.

15. A communication device as in claim 14, wherein the device is wireless.

16. A call alert blocking system implemented as a call alert blocking service to a called party by a telephone service provider, the called party wishing to block a particular call alert upon a call termination attempt by a calling party, the call alert system comprising:
selection means for the called party to select a call alert to be blocked with a call from the calling party; and
processing means for blocking the selected call alert to the called party.

17. For use in a communication network, a method for a calling party to provide a selected call alert to a called party upon a call termination attempt, the method comprising:
selecting one of a plurality of call alerts to be provided with the call to the called party; and
processing the selected call alert and providing the selected call alert to the called party on the call termination attempt.

18. For use in a communication network, a method for a called party to provide a selected calling alert to a calling party upon a call termination attempt, the method comprising:
selecting one of a plurality of calling alerts to be provided to the calling party upon the call termination attempt; and
processing the selected calling alert and providing the selected calling alert to the calling party on the call termination attempt.

19. A method as in claim 17, wherein the communication network includes a wireless telephone network.

20. A method as in claim 18, wherein the communication network includes a wireless telephone network.
